(19) United States
(12) Patent Application Publication
(10) Pub. No.: US 2025/0386834 A1
(43) Pub. Date: Dec. 25, 2025

(54) NORMAL-TEMPERATURE LONG-TIME FRESHNESS RETAINING METHOD

(71) Applicant: Jiangsu Academy of Agricultural Sciences, Nanjing (CN)

(72) Inventors: Hongwu Bai, Nanjing (CN); Renkui Jiang, Nanjing (CN)

(21) Appl. No.: 19/315,717

(22) Filed: Sep. 1, 2025

(30) Foreign Application Priority Data
Aug. 5, 2025 (CN) 202511088159.8

(51) Int. Cl. A23B 7/015; A23B 7/14

(52) U.S. Cl. CPC A23B 7/015; A23B 7/14; A23V 2002/00

(57) ABSTRACT

A normal-temperature long-time freshness retaining method is provided, which relates to the field of processing and freshness retaining of fresh-cut vegetables. An irradiation disinfection module and an online monitoring unit are included. The irradiation disinfection module is in charge of disinfecting cut vegetables. The irradiation disinfection module controls irradiation disinfection equipment and a sprayer, so that ultraviolet rays are used to assist in sterilization while a natural preservative is sprayed, thereby achieving a purpose of efficient combination and freshness retaining. The online monitoring unit performs, through a sensor, real-time detection on the vegetables being disinfected, to ensure that vegetable disinfection meets a production standard, and transmits a detected result to an automatic feedback module. Meanwhile, because of non-toxic and environmentally-friendly characteristics, a natural component is more in line with a healthy consumption need.

### TECHNICAL FIELD

The present disclosure relates to the technical field of processing and freshness retaining of fresh-cut vegetables, and in particular to, a normal-temperature long-time freshness retaining method.

### BACKGROUND

Fresh-cut vegetables, as an important category of convenient food, have a surge demand in fields such as catering and retail because they can be directly eaten after being peeled, cut, or subjected to other pretreatments. A freshness retaining technology is a core of ensuring the product quality (such as the taste and the nutrition) and prolonging the shelf life, which is directly related to food safety, supply chain efficiency, and industrial economic benefits.

To solve the problems of microbial contamination, browning, and nutrient loss in the fresh-cut vegetables due to mechanical, a series of freshness retaining methods have been developed in the existing technology: by adding an edible acid (such as a citric acid) and a synthetic chemical agent (such as sodium hypochlorite and CIO₂) to inhibit microbial reproduction, the freshness retaining time is prolonged in conjunction with acidification, pasteurization, and the like. For example, some technologies enhance a sterilization effect by adjusting a pH to 4.6 or below. After the pasteurization, vegetables need to be quickly cooled to 13° C. or below and continuously refrigerated to delay rotting, thus prolonging the freshness retaining time to 7 to 14 days. A standardized production line including “cleaning, peeling, disinfection, and cutting” is used. In the disinfection procedure, sodium hypochlorite is generally used. The disinfection is completed based on a preset concentration, time, and another parameter.

An existing fresh-cut vegetable freshness retaining technology has the following defects:

The fresh-cut vegetables are prone to microbial contamination, browning, and nutrient loss because of the mechanical damage caused by peeling, cutting, and another processing. The fresh-cut vegetables have a short shelf life and need to rely on chemical preservatives and cold chain chemical preservatives. In most freshness retaining methods (such as acidification and pasteurization), the edible acid (such as citric acid) or the synthetic chemical agent (such as sodium hypochlorite and ClO₂) needs to be added to inhibit microorganisms, but a residual chemical agent may affect safety and taste of food. For example, the existing patent (U.S. Pat. No. 6,596,331B1) uses acidification and pasteurization to treat cooked wheaten food. The pH needs to be adjusted to 4.6 or below, and heat treatment and refrigeration are required. Similarly, the sodium hypochlorite is commonly used for disinfection during fresh-cut vegetable treatment, but chemical residues may lead to secondary pollution.

Necessity of refrigeration: in the existing freshness retaining technology (as described), the vegetables need to be quickly cooled to approximately 2 to 8° C. or below after pasteurization and continuously refrigerated, to prolong the freshness retaining time to 7 to 14 days. However, this increases energy consumption and costs, and cold chain breakage can easily lead to rotting of a product.

Short freshness retaining time: traditional fresh-cut vegetables have freshness retaining time of only 3 to 5 days. Even the fresh-cut vegetables are optimized with an optimization process (such as using a Nisin biological preservative), it is difficult to prolong the freshness retaining time to be more than 7 days at normal temperature, and the fresh-cut vegetables still partially rely on a chemical additive.

Device limitation: The existing production line (such as cleaning, peeling, disinfection, and cutting) lack intelligent control, and the sodium hypochlorite is fixedly used in the disinfection procedure, so that freshness retaining parameters (such as the concentration and the pH) cannot be adjusted. As a result, the efficiency is low, and chemical agents are abused.

The present disclosure provides an innovative solution to solve the above problems: by screening natural preservatives and developing an efficient combined device, and an irradiation disinfection technology, “0 chemical preservative” and normal-temperature long-time freshness retaining are implemented, thus overcoming the bottlenecks in the existing technology.

### SUMMARY

For the shortcomings in the existing technology, the present disclosure provides a normal-temperature long-time freshness retaining method, which solves the problems that an existing fresh-cut vegetable freshness retaining technology relies on a chemical preservative, requires a cold chain, and has short freshness retaining time, and a device lacks intelligent control.

To achieve the above objectives, the present disclosure is implemented through the following solutions: a control system for normal-temperature long-time freshness retaining including an irradiation disinfection module, an online monitoring unit, and an automatic feedback module.

The irradiation disinfection module is in charge of disinfecting cut vegetables; the irradiation disinfection module controls irradiation disinfection equipment and a sprayer, so that ultraviolet rays are used to assist in sterilization while a natural preservative is sprayed, thereby achieving a purpose of efficient combination and freshness retaining.

The online monitoring unit performs, through a sensor, real-time detection on the vegetables being disinfected, to ensure that vegetable disinfection meets a production standard, and transmits a detected result to an automatic feedback module.

The automatic feedback module is configured to: receive a detected value in the online monitoring unit and adjust an irradiation dose and a preservative flow rate based on the detected value and an adjustment plan.

The irradiation disinfection equipment in the irradiation disinfection module includes: an ultraviolet lamp or an electron beam irradiation source.

The sensor in the online monitoring unit includes: a pH sensor, a bacterial concentration sensor, and a temperature sensor.

The real-time detection in the online monitoring unit includes: detecting a pH, a bacterial concentration, and a temperature of the vegetables.

The adjustment plan in the automatic feedback module includes:
when a bacterial concentration detected value is greater than 5 CFU/g, automatically increasing the irradiation dose to 1 kGy while keeping a preservative flow rate constant;
when a pH is less than 4.5, decreasing a flow rate of an acidic natural preservative and increasing a flow rate of a neutral preservative; when a pH is greater than 6.0, increasing a flow rate of an ascorbic acid to stabilize the pH; and
when a temperature is greater than 25° C., slowing down a linkage conveyor belt to prolong irradiation time by 5 to 10 seconds, and increasing a preservative spray by 10% to improve oxidation resistance.

A use method of the control system for normal-temperature long-time freshness retaining includes the following steps:
S1, screening of a natural preservative: obtaining extracts from natural plants through a standardized extraction process, and selecting, based on index testing on a taste, an antibacterial effect, a nutrition retaining effect, and the like, an optimal natural preservative combination that has no chemical additive and is safe and efficient, to provide a core raw material foundation for subsequent freshness retaining;
S101, raw materials and extraction: obtaining the extracts from the natural plants by using the standardized extraction process based on an existing vegetable combination;
the existing vegetable combination including leaf vegetables and root vegetables;
the standardized extraction process including water extraction or alcohol extraction;
the natural plants including tea polyphenol and a konjac glucomannan source;
S102, index testing: carrying out in-vitro antibacterial experiment by using the taste, a browning rate, a total number of bacteria, and the nutrition retaining effect as measurement indexes, and selecting the optimal natural preservative combination;
the total number of bacteria including a total number of coliform bacteria and a total number of Staphylococcus aureus;
the nutrition retaining effect including a VC retaining effect and a total acid retaining effect;
the optimal natural preservative combination including a compound ascorbic acid, tea polyphenol, and salicylic acid; a ratio of the compound ascorbic acid, the tea polyphenol, and the salicylic acid being 300 mg/L:30 mg/L:10 mg/L; an antibacterial effect of the optimal natural preservative combination being better than an antibacterial effect of a single chemical agent, and the optimal natural preservative combination being non-toxic and environmentally-friendly;
S2, multi-factor control variable freshness retaining process: designing a multi-factor orthogonal experiment for different vegetable varieties, and optimizing parameters such as a natural preservative concentration and an irradiation dose with goals of browning inhibition, bacterial reduction, and the nutrition retaining effect;
S201, experiment design: for different vegetable varieties, carrying out multi-factor orthogonal experiment, variables of the multi-factor orthogonal experiment including the natural preservative concentration, the irradiation dose, treatment time, and an ambient temperature;
the different vegetable varieties including lettuces and carrots;
S202, optimization of the goals: determining an efficient combination parameter by using a browning inhibition rate greater than or equal to 90%, a bacterial reduction rate greater than or equal to 95%, and a nutrition retaining effect rate greater than or equal to 85% as indexes;
the efficient combination parameters including: irradiation disinfection and natural preservative spraying are combined to replace the sodium hypochlorite, which significantly reduces microbial contamination;
S3, efficient combination treatment: treating the cut vegetables in sequence based on the efficient combination parameters determined in step S2, specifically:
first controlling the irradiation disinfection equipment through the irradiation disinfection module, then sterilizing the vegetables for 1 to 10 minutes based on the irradiation dose parameter in S2, finally synchronously turning on the sprayer to uniformly spray the natural preservative selected in S1, and turning on an ultraviolet lamp to assist in sterilization, to implement “irradiation+natural preservative” collaborative treatment;
S4, online monitoring and dynamic adjustment: performing real-time detection on the vegetables being treated through the pH sensor, the bacterial concentration sensor, and the temperature sensor of the online monitoring unit, focusing on monitoring the pH, the total number of bacteria, and the ambient temperature, and performing dynamic optimization and adjustment based on an adjustment plan; and
S5, normal-temperature storage: after the above treatment, hermetically packaging the vegetables, and storing the vegetables at a normal temperature of 15 to 25° C.

The present disclosure provides a normal-temperature long-time freshness retaining method, which has the following beneficial effects:
1. The present discloses selects the natural preservative combination to completely replace a traditional chemical preservative, which implements “0 chemical additive”, thus avoiding a food safety risk and taste impact that are caused by chemical agent residues. Meanwhile, because of non-toxic and environmentally-friendly characteristics, a natural component is more in line with a healthy consumption need.
2. By using the collaborative process of “irradiation disinfection+natural preservative spraying” and combining the design of storage at the normal temperature of 15 to 25° C., the present disclosure does not need to rely on refrigeration, so that the dependence of the traditional technology on a cold chain is overcome; energy consumption and costs that are related to the cold chain are reduced. Meanwhile, the problem of product rotting caused by breakage of the cold chain is avoided.
3. Through the online monitoring and automatic feedback system, based on the real-time detected data such as the pH, the bacterial concentration which is, for example, greater than 5 CFU/g, and the temperature which is, for example, greater than 25° C., the present disclosure dynamically adjusts the parameters, such as the irradiation dose, for example, increasing the irradiation dose by 1 kGy, the preservative flow rate, for example, increasing the spray by 10%, and the treatment time, for example, prolonging the treatment time by 5 to 10 seconds. This solves limitations such as fixed parameters and low efficiency of a traditional production line, improves accuracy and stability of freshness retaining treatment, and can meet demands of different vegetable varieties.

### BRIEF DESCRIPTION OF THE DRAWINGS

FIG. 1 is a flowchart of a system according to the present disclosure; and

FIG. 2 is a flowchart of a method according to the present disclosure.

### DETAILED DESCRIPTION OF THE EMBODIMENTS

The following clearly and completely describes the technical solutions in the embodiments of the present disclosure with reference to the accompanying drawings of this specification of the present disclosure. Apparently, the described embodiments are some of the embodiments of the present disclosure rather than all the embodiments. Based on the embodiments of the present disclosure, all other embodiments obtained by those of ordinary skilled in the art without creative efforts fall within the protection scope of the present disclosure.

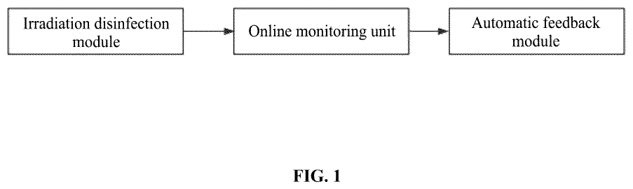

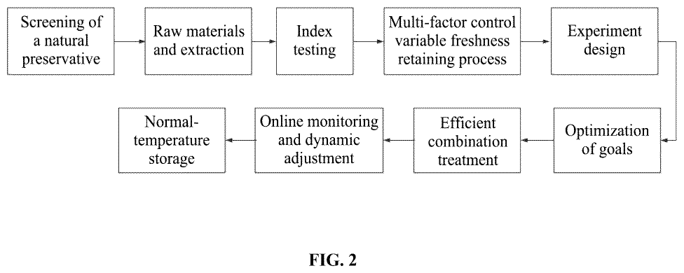

Referring to FIG. 1 to FIG. 2, an embodiment of the present disclosure provides a control system for normal-temperature long-time freshness retaining, including an irradiation disinfection module, an online monitoring unit, and an automatic feedback module.

The irradiation disinfection module is in charge of disinfecting cut vegetables; the irradiation disinfection module controls irradiation disinfection equipment and a sprayer, so that ultraviolet rays are used to assist in sterilization while a natural preservative is sprayed, thereby achieving a purpose of efficient combination and freshness retaining.

The irradiation disinfection equipment includes an ultraviolet lamp or an electron beam irradiation source.

The online monitoring unit performs, through a sensor, real-time detection on the vegetables being disinfected, to ensure that vegetable disinfection meets a production standard, and transmits a detected result to an automatic feedback module.

The sensor includes: a pH sensor, a bacterial concentration sensor, and a temperature sensor.

The real-time detection includes: detecting a pH, a bacterial concentration, and a temperature of the vegetables.

The automatic feedback module is configured to: receive a detected value in the online monitoring unit and adjust an irradiation dose and a preservative flow rate based on the detected value and an adjustment plan. The adjustment plan is specifically as follows: when a bacterial concentration detected value is greater than 5 CFU/g, automatically increasing the irradiation dose to 1 kGy while keeping a preservative flow rate constant;
when a pH is less than 4.5, decreasing a flow rate of an acidic natural preservative and increasing a flow rate of a neutral preservative; when a pH is greater than 6.0, increasing a flow rate of an ascorbic acid to stabilize the pH; and
when a temperature is greater than 25° C., slowing down a linkage conveyor belt to prolong irradiation time by 5 to 10 s, and increasing a preservative spray by 10% to improve oxidation.

A use method of the control system for normal-temperature long-time freshness retaining includes the following steps:
S1, screening of a natural preservative: obtaining extracts from natural plants through a standardized extraction process, and selecting, based on index testing on a taste, an antibacterial effect, a nutrition retaining effect, and the like, an optimal natural preservative combination that has no chemical additive and is safe and efficient, to provide a core raw material foundation for subsequent freshness retaining;
S101, raw materials and extraction: obtaining the extracts from the natural plants by using the standardized extraction process based on an existing vegetable combination;
the existing vegetable combination including leaf vegetables and root vegetables;
the standardized extraction process including water extraction or alcohol extraction;
the natural plants including tea polyphenol and a konjac glucomannan source;
S102, index testing: carrying out in-vitro antibacterial experiment by using the taste, a browning rate, a total number of bacteria, and the nutrition retaining effect as measurement indexes, and selecting the optimal natural preservative combination;
the total number of bacteria including a total number of coliform bacteria and a total number of Staphylococcus aureus;
the nutrition retaining effect including a VC retaining effect and a total acid retaining effect;
the optimal natural preservative combination including a compound ascorbic acid, tea polyphenol, and salicylic acid; a ratio of the compound ascorbic acid, the tea polyphenol, and the salicylic acid being 300 mg/L:30 mg/L:10 mg/L; an antibacterial effect of the optimal natural preservative combination being better than an antibacterial effect of a single chemical agent, and the optimal natural preservative combination being non-toxic and environmentally-friendly;
S2, multi-factor control variable freshness retaining process: designing a multi-factor orthogonal experiment for different vegetable varieties, and optimizing parameters such as a natural preservative concentration and an irradiation dose with goals of browning inhibition, bacterial reduction, and the nutrition retaining effect;
S201, experiment design: for different vegetable varieties, carrying out multi-factor orthogonal experiment, variables of the multi-factor orthogonal experiment including the natural preservative concentration, the irradiation dose, treatment time, and an ambient temperature;
the different vegetable varieties including lettuces and carrots;
S202, optimization of the goals: determining an efficient combination parameter by using a browning inhibition rate greater than or equal to 90%, a bacterial reduction rate greater than or equal to 95%, and a nutrition retaining effect rate greater than or equal to 85% as indexes;
the efficient combination parameters including: irradiation disinfection (3 kGy) and natural preservative spraying are combined to replace the sodium hypochlorite, which significantly reduces microbial contamination;
S3, efficient combination treatment: treating the cut vegetables in sequence based on the efficient combination parameters determined in step S2, specifically:
first controlling the irradiation disinfection equipment through the irradiation disinfection module, then sterilizing the vegetables for 1 to 10 minutes based on the irradiation dose parameter in S2, finally synchronously turning on the sprayer to uniformly spray the natural preservative selected in S1, and turning on an ultraviolet lamp to assist in sterilization, to implement “irradiation+natural preservative” collaborative treatment;
S4, online monitoring and dynamic adjustment: performing real-time detection on the vegetables being treated through the pH sensor, the bacterial concentration sensor, and the temperature sensor of the online monitoring unit, focusing on monitoring the pH, the total number of bacteria (CFU/g), and the ambient temperature, and performing dynamic optimization and adjustment based on an adjustment plan; and
S5, normal-temperature storage: after the above treatment, hermetically packaging the vegetables, and storing the vegetables at a normal temperature of 15 to 25° C.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A control system for normal-temperature long-time freshness retaining, comprising:
an irradiation disinfection module, wherein the irradiation disinfection module is in charge of disinfecting cut vegetables; the irradiation disinfection module controls irradiation disinfection equipment and a sprayer, so that ultraviolet rays are used to assist in sterilization while a natural preservative is sprayed, thereby achieving a purpose of efficient combination and freshness retaining;
an online monitoring unit, wherein the online monitoring unit performs, through a sensor, real-time detection on the vegetables being disinfected, to ensure that vegetable disinfection meets a production standard, and transmits a detected result to an automatic feedback module; and
the automatic feedback module, configured to: receive a detected value in the online monitoring unit and adjust an irradiation dose and a preservative flow rate based on the detected value and an adjustment plan.

2. The control system for normal-temperature long-time freshness retaining according to claim 1, wherein the irradiation disinfection equipment in the irradiation disinfection module comprises: an ultraviolet lamp or an electron beam irradiation source.

3. The control system for normal-temperature long-time freshness retaining according to claim 1, wherein the sensor in the online monitoring unit comprises: a pH sensor, a bacterial concentration sensor, and a temperature sensor.

4. The control system for normal-temperature long-time freshness retaining according to claim 1, wherein the real-time detection in the online monitoring unit comprises: detecting a pH, a bacterial concentration, and a temperature of the vegetables.

5. The control system for normal-temperature long-time freshness retaining according to claim 1, wherein the adjustment plan in the automatic feedback module comprises:
when a bacterial concentration detected value is greater than 5 CFU/g, automatically increasing the irradiation dose to 1 kGy while keeping a preservative flow rate constant;
when a pH is less than 4.5, decreasing a flow rate of an acidic natural preservative and increasing a flow rate of a neutral preservative; when a pH is greater than 6.0, increasing a flow rate of an ascorbic acid to stabilize the pH; and
when a temperature is greater than 25° C., slowing down a linkage conveyor belt to prolong irradiation time by 5 to 10 seconds, and increasing a preservative spray by 10% to improve oxidation resistance.

6. A use method of the control system for normal-temperature long-time freshness retaining according to claim 1, comprising the following steps:
S1, screening of a natural preservative: obtaining extracts from natural plants through a standardized extraction process, and selecting, based on index testing on a taste, an antibacterial effect, a nutrition retaining effect, and the like, an optimal natural preservative combination that has no chemical additive and is safe and efficient, to provide a core raw material foundation for subsequent freshness retaining;
S101, raw materials and extraction: obtaining the extracts from the natural plants by using the standardized extraction process based on an existing vegetable combination;
the existing vegetable combination comprising leaf vegetables and root vegetables;
the standardized extraction process comprising water extraction or alcohol extraction;
the natural plants comprising tea polyphenol and a konjac glucomannan source;
S102, index testing: carrying out in-vitro antibacterial experiment by using the taste, a browning rate, a total number of bacteria, and the nutrition retaining effect as measurement indexes, and selecting the optimal natural preservative combination;
the total number of bacteria comprising a total number of coliform bacteria and a total number of Staphylococcus aureus;
the nutrition retaining effect comprising a VC retaining effect and a total acid retaining effect;
the optimal natural preservative combination comprising a compound ascorbic acid, tea polyphenol, and salicylic acid; a ratio of the compound ascorbic acid, the tea polyphenol, and the salicylic acid being 300 mg/L:30 mg/L:10 mg/L; an antibacterial effect of the optimal natural preservative combination being better than an antibacterial effect of a single chemical agent, and the optimal natural preservative combination being non-toxic and environmentally-friendly;
S2, multi-factor control variable freshness retaining process: designing a multi-factor orthogonal experiment for different vegetable varieties, and optimizing parameters such as a natural preservative concentration and an irradiation dose with goals of browning inhibition, bacterial reduction, and the nutrition retaining effect;
S201, experiment design: for different vegetable varieties, carrying out multi-factor orthogonal experiment, variables of the multi-factor orthogonal experiment comprising the natural preservative concentration, the irradiation dose, treatment time, and an ambient temperature;
the different vegetable varieties comprising lettuces and carrots;
S202, optimization of the goals: determining an efficient combination parameter by using a browning inhibition rate greater than or equal to 90%, a bacterial reduction rate greater than or equal to 95%, and a nutrition retaining effect rate greater than or equal to 85% as indexes;
the efficient combination parameters comprising: irradiation disinfection and natural preservative spraying are combined to replace the sodium hypochlorite, which significantly reduces microbial contamination;
S3, efficient combination treatment: treating the cut vegetables in sequence based on the efficient combination parameters determined in step S2, specifically:
first controlling the irradiation disinfection equipment through the irradiation disinfection module, then sterilizing the vegetables for 1 to 10 minutes based on the irradiation dose parameter in S2, finally synchronously turning on the sprayer to uniformly spray the natural preservative selected in S1, and turning on an ultraviolet lamp to assist in sterilization, to implement “irradiation+natural preservative” collaborative treatment;
S4, online monitoring and dynamic adjustment: performing real-time detection on the vegetables being treated through the pH sensor, the bacterial concentration sensor, and the temperature sensor of the online monitoring unit, focusing on monitoring the pH, the total number of bacteria, and the ambient temperature, and performing dynamic optimization and adjustment based on an adjustment plan; and
S5, normal-temperature storage: after the above treatment, hermetically packaging the vegetables, and storing the vegetables at a normal temperature of 15 to 25° C.
